(19) United States
(12) Patent Application Publication
(10) Pub. No.: US 2008/0008456 A1
(43) Pub. Date: Jan. 10, 2008

(54) Method and apparatus for time/date and/or session-limited temporary storage and playback of proprietary and non-proprietary media content utilizing re-writeable non-volatile memory.

(76) Inventors: David B. Buttars, Park City, UT (US); Vincent C. Romney, Herriman, UT (US)

Correspondence Address: MADSON & AUSTIN, 15 WEST SOUTH TEMPLE, SUITE 900, SALT LAKE CITY, UT, 84101, US

(21) Appl. No.: 11/161,271

(22) Filed: Jul. 28, 2005

(51) Int. Cl. H04N 5/00

(52) U.S. Cl. 386/125; 386/E05.067

(57) ABSTRACT

The present invention comprises a method and apparatus for temporary storage and playback of proprietary and non-proprietary media content and other works temporarily recorded on a re-writeable, non-volatile solid-state memory device. One embodiment of the invention relates to media such as motion pictures and other audio/video programs or works. The invention involves a manner of utilizing re-writeable, non-volatile, solid-state storage media (such as Flash memory), including but not limited to a USB-memory key or similar device, to transfer proprietary and non-proprietary content such as the above referenced motion picture and other audio/video programs or works, from a distribution source such as a video rental facility, to the re-writeable, non-volatile, solid-state storage media, and then to a user's viewing location (home, office, or other remote location), and allowing viewing of said content through a set-top box or other specifically designed playback device for a limited period of time, at the expiration of which time the re-writeable storage device automatically and permanently erases the recorded content leaving the storage device ready to receive and again temporarily store and playback new content. Because of the increasingly large capacity of non-volatile memory to store content, the content provider/rental facility can allow for storage of any number of motion picture and other audio/video programs, and said provider/rental facility can set varying expirations for each of the stored motion picture and other audio/video programs.

### BACKGROUND OF THE INVENTION

1. Field of the Invention

The invention relates to a method and apparatus for storage and playback of video, audio, multimedia and other data recorded on re-writeable, non-volatile, solid-state storage media.

2. Background Art

In the current environment, when you wish to view a movie that has been released on DVD or Video Cassette, the movie is rented for some period of time from a rental location (Blockbuster™, Hollywood Video™, or similar) at the end of said period of time the DVD or Video Cassette must be returned to the rental location. Alternative rental modalities (MovieBeam™, NetFlix™, or similar) offer either significantly less selection, or the need to receive and return the DVD or Video Cassette back to the rental location via a postal/mail service. The perennial problem for consumers of video rental services is the need to return the DVD or Video Cassette after the prescribed viewing period or incur fines or other penalties, or the fact that alternative rental modalities have significantly lower selections, and do not offer the “browsing” capability offered by a “brick and mortar” rental facility. Some services have attempted to remove the need to return the DVD media by creating “degrading” DVD media which become unreadable and thus unusable after a certain time period. This absolves the user of the need to return the DVD media itself, but adds considerably to the cost of goods for the rental facility, and creates significant waste if these degradable DVD's are utilized to any great degree. Despite the need to return the DVD or Video Cassette, and the possible late fees or other fees associated with renting programs from “brick and mortar” rental facilities, consumers are still attracted to these sites because of the vast selection and the ability to browse not only categories and titles, but the actual packaging of the movies. Brick and mortar facilities have attempted to mitigate the negatives associated with their services by creating “no late fee” policies, but these are still tied to the need to return the DVD or Video Cassette at some point.

### SUMMARY OF THE INVENTION

The present invention comprises a method and apparatus for playback of programs and other works recorded on re-writeable, non-volatile, solid-state storage media. One embodiment of the invention relates to re-writeable, non-volatile, solid-state storage media used to distribute motion pictures and other audio/video data, programs or works. The data stored on said storage media is stored with pre-determined playback criteria, which determines the allowed number of playback sessions, or the time-period where the recorded data remains useable. After the allowed number of playback sessions have been used, or the pre-determined time-period has elapsed, the data set to which the playback criteria is assigned is permanently erased, and the storage media is prepared to receive new data sets during the next visit to the rental facility or internet rental site.

For example, a “key-drive” form-factor utilizing re-writeable, non-volatile, solid-state storage media, and a corresponding “set-top-box” playback device would be provided to the consumer at the rental facility. At some future point, it is envisioned that the interface for the storage device would be integrated into the actual television set or other viewing device. This “key-drive” would then be loaded with the consumer's choice of programs, and the playback criteria set to the number of viewings or the time-period for viewing the consumer desires for each program. The consumer returns home and is able to view the programs according to the pre-determined playback criteria, after which the media erases itself and is ready to load new programs from the rental facility at the consumer's convenience.

In one embodiment of the invention, the consumer would choose several movies, and could assign the same playback criteria to all of the movies, or could assign each movie a separate set of playback criteria. After setting these playback criteria and paying the rental fees the consumer can leave with the “key-drive”. After arriving at their home or other viewing location, the consumer places the “key-drive” into the interface of the “set-top-box” and can then view each program as desired according to the playback criteria.

In one embodiment of the invention, the consumer may choose to utilize an “online” service wherein the consumer would download programs from the internet and load them through their computer onto the “key-drive”. The “online” service would provide the same functionality of setting playback criteria, and paying for the rental, but would also offer the option to pay for and modify already set playback criteria for any of the programs already loaded onto the “key-drive”.

### BRIEF DESCRIPTION OF THE FIGURES

FIG. 1 is a block diagram of a video viewing component system that can be used with an embodiment of the invention.

FIG. 2 is a block diagram of a computer system that can be used with an embodiment of the invention.

FIG. 3 is a graphical representation of a re-writeable, non-volatile, solid-state storage medium on which media content data files are recorded in accordance with an embodiment of the invention.

FIG. 4 is a flow chart of a method that may be used to store media content as data files onto re-writeable, non-volatile, solid-state storage medium of FIG. 3 for playback in an embodiment of the invention.

FIG. 5 is a flow chart of a method that may be used to playback the media content stored as data files on storage medium of FIG. 3.

FIG. 6 is a flow chart of a method that may be used to modify playback criteria for media content stored as data files on storage medium of FIG. 3.

### DETAILED DESCRIPTION OF THE INVENTION

A method and apparatus for storage and playback of programs recorded on re-writeable, non-volatile, solid-state storage media is described. In the following description, numerous specific details are set forth in order to provide a thorough understanding of the invention. It will be apparent, however, to one skilled in the art, that the invention may be practiced without these specific details. In other instances, well-known features have not been described in detail in order not to obscure the invention.

The invention can be implemented using any type of re-writeable, non-volatile, solid-state storage media. Examples include, without limitation, flash memory, nano-film based memory, memory sticks of various types, RAM cards, and other specific and non-specific re-writeable, non-volatile, solid-state storage media.

One embodiment uses a memory stick (or Flash Drive) as the re-writeable, non-volatile, solid-state storage media. In this embodiment, the re-writeable, non-volatile, solid-state storage media contains one or more program files, such as motion pictures, musical performances, and a plurality of secondary programs, such as movie trailers and product advertisements. The invention is, however, equally applicable to other types of primary and secondary programs, including musical recordings, computer software (including computer games, simulations and virtual environments), video recordings, multi-media programs, etc.

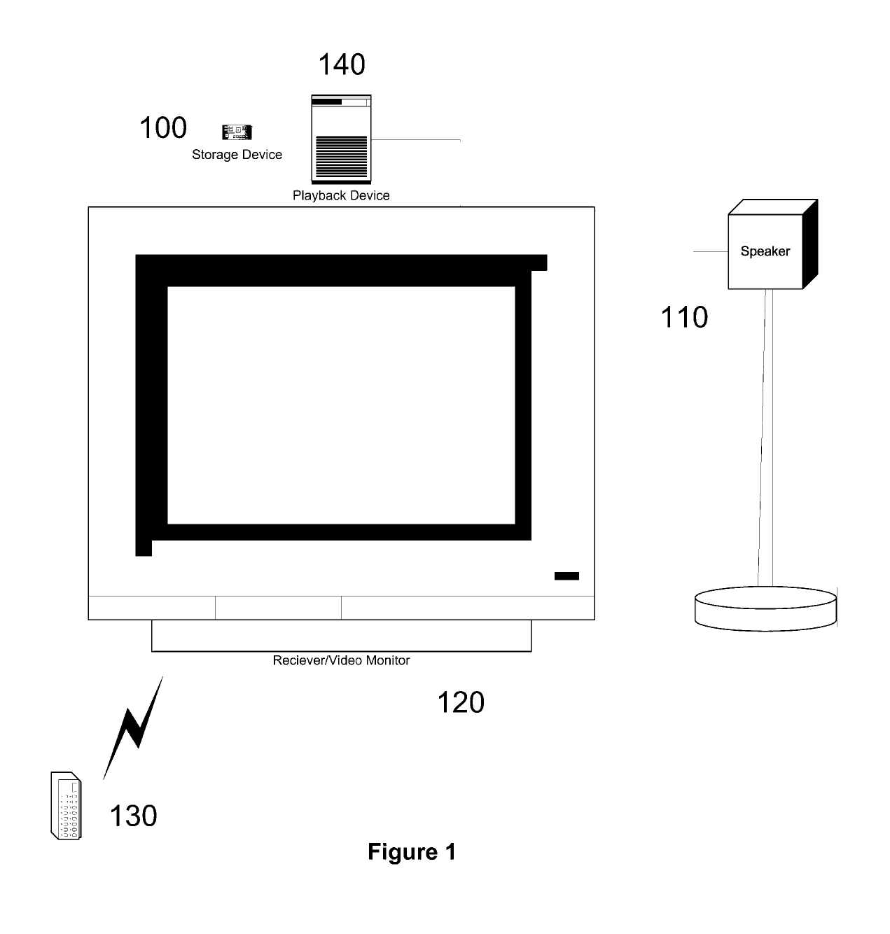

FIG. 1 shows an example of apparatus that may be used to playback media content stored as data files recorded on a re-writeable, non-volatile, solid-state storage media in one embodiment of the invention. The apparatus of FIG. 1 includes a re-writeable, non-volatile, solid-state storage media (such as a memory stick, “Flash Drive”, or other) component 100 which is inserted into a playback device 140, which is in-turn connected to a receiver and/or video monitor 120 and, in this embodiment of the invention, a sound system 110 is connected. The playback device 140 is as described in 29 below, and provides a video signal output and any corresponding sound output, or simply a sound output in the case of audio only recordings, and subsequently displaying it on video monitor 120. Monitor 120 is any kind of display monitor that can display the video signal received from playback device 140. Monitor 120 may, for example, comprise a cathode ray tube monitor, a projection monitor, a gas plasma monitor, an LCD monitor, etc. Sound system 110 is any kind of sound amplifier and speaker system capable of reproducing an audio signal output by playback device component 140. Sound system 110 may, for example, comprise a stereo amplifier and speaker system, and may include features such as, for example, Dolby™ surround sound compatibility. Monitor 120 and sound system 110 may comprise separate components or may be integrated into one or more combined units. Control of playback device 140 may be controlled via a remote control device 130 specific to playback device 140, or a remote control device 130 compatible with any or all of the components 110, 120, and/or other components not mentioned, but capable of being controlled via such remote control device 130.

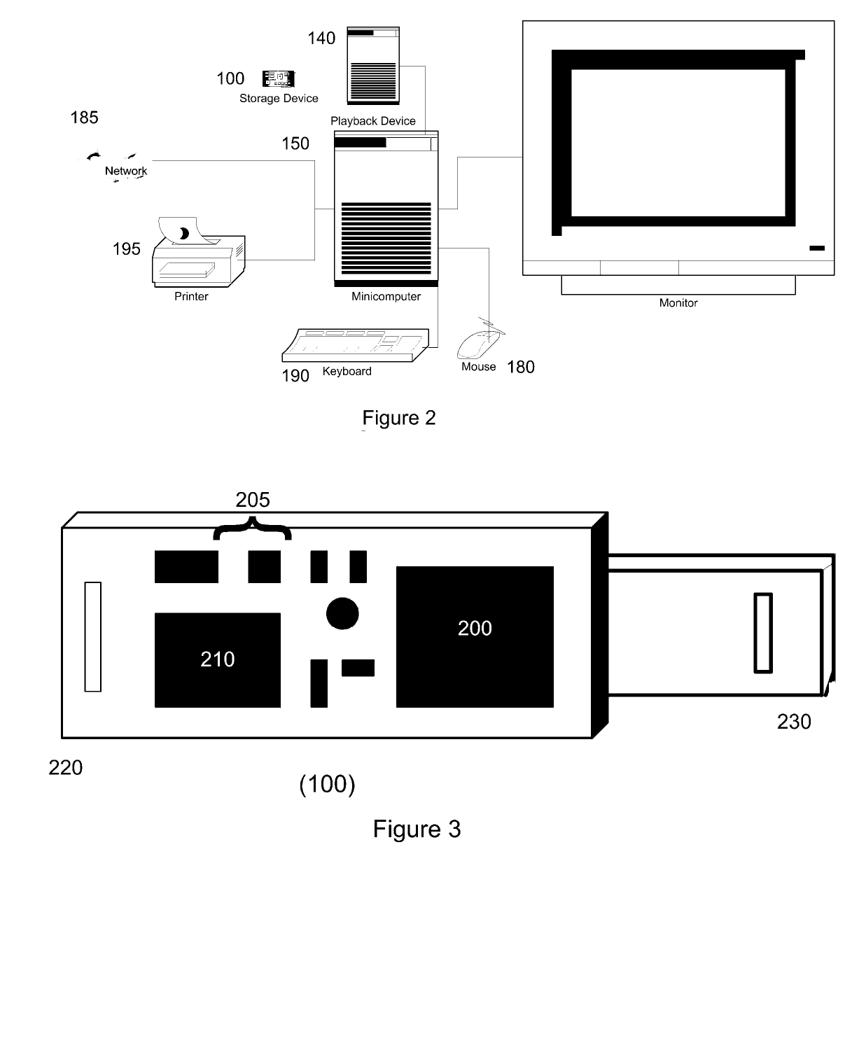

FIG. 2 shows a computer system that may be used to playback media content stored as data files recorded on a re-writeable, non-volatile, solid-state storage media in one embodiment of the invention. The computer system shown in FIG. 2 includes a CPU unit 150 that includes a central processor, main memory, peripheral interfaces, input-output devices, power supply, and associated circuitry and devices; a display device 170 which may be a cathode ray tube display, LCD display, gas-plasma display, or any other computer display; a keyboard input device 190, and/or a secondary input device 180 which may include a mouse, digitizer, or other input device; and a playback device 140 for retrieving data stored on a re-writeable, non-volatile, solid-state storage media 100. The computer system may or may not include non-volatile storage, which may include magnetic, optical, or other mass storage devices, and a printer 195. The computer system may also include a network interface 185, which may include a modem, allowing the computer system to communicate with other systems over a communications network such as the Internet. Any of a variety of other configurations of computer systems may also be used.

FIG. 3 is a graphical representation a re-writeable, non-volatile, solid-state storage medium. The re-writeable, non-volatile, solid-state storage medium shown in FIG. 3 may comprise a memory stick, “Flash Drive” or any other suitable re-writeable, non-volatile, solid-state storage media.

In FIG. 3, storage medium 100 includes one or more re-writeable, non-volatile, solid-state storage medium (a memory “chip”) 200, a processor 210 for executing computer processor readable program code embodied and stored on the memory chip 200, and support chipset and electronics 205 which support the execution of said computer processor readable program code. File system information which contains information about the file system structure used to store data on memory chip 200 may also be stored on memory chip 200 using any number of partitioning technologies, known to those skilled in the art, or may be stored on an alternative memory chip collocated with memory chip 200, or as part of the support chipset and electronics 205. File system information area may also contain directory information indicating the identity and storage location of programs stored on memory chip 200. Playback criteria and user account information may likewise be stored on memory chip 200 or stored on an alternative memory chip collocated with memory chip 200, or as part of the support chipset and electronics 205.

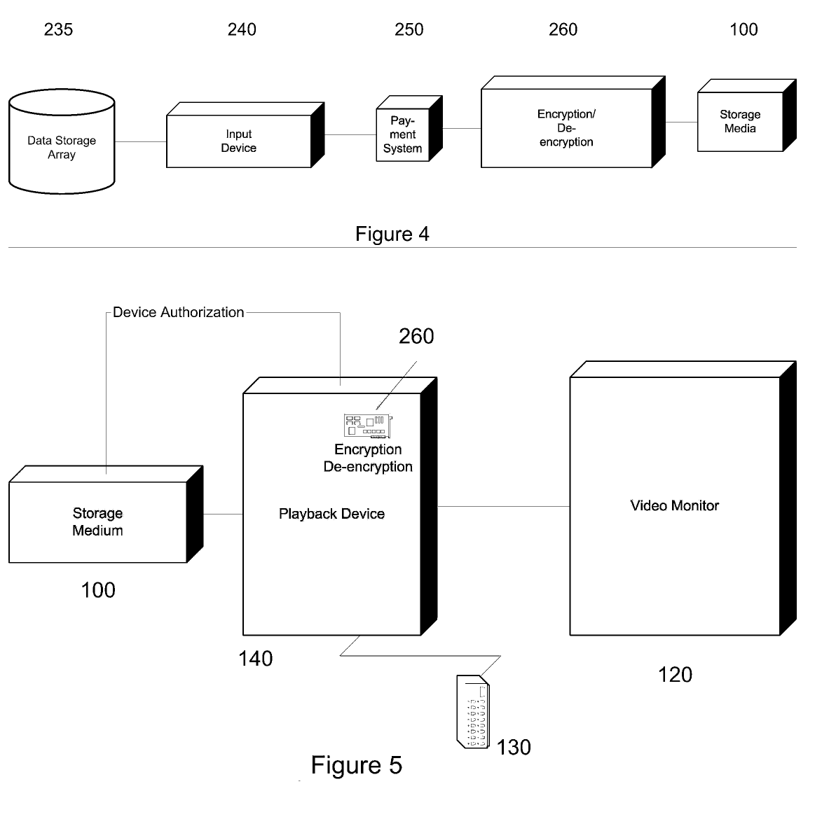

FIG. 4 is a flow chart of a method that may be used to store media content data files on storage medium 100 of FIG. 1. In this embodiment, media content is stored as one or more data files on the memory chip 200 and linked to playback criteria set at the time of initial storage on memory chip 200 or on support chips 205, or to playback criteria modified after the time of initial storage on memory chip 200 or on support chips 205. Playback criteria may remain stored on memory chip 200, or on support chips 205 and act as “default” playback criteria in the absence of newer playback criteria, thus retaining the user's preferential playback criteria through multiple storing and deletion cycles. The method of storing media content data files may be controlled and implemented by the user, a store clerk, or by some other means of either manual or automated processes known to those skilled in the art. In this embodiment, the user may provide the storage medium 100 to the media rental clerk with a selection of desired media programs, and the clerk will load the desired media content data files onto the storage medium 100 and apply playback criteria to each file as per the user's instructions, or as per default store policy, or may simply default to existing playback criteria previously stored on storage medium 100.

According to the method of FIG. 4, the storage process begins with a storage library of any number of media content data files stored at 235, where all video, audio, or other media content data files are stored on a referenced database, or in any of a multitude of data storage systems known to those skilled in the art. Data transfer from the data storage system 235 to the storage medium 100 is initiated by instructions input at input device 240, which device may be a data-entry terminal, desktop computer, cash register terminal, or any other input device either specifically designed for such function, or modified through attachment, integration, or some other method to function as said input device. Each instruction for a transfer of data from storage system 235 to storage medium 100 is authorized, and payment transacted by reference to the payment account system 250. Payment account system 250 applies charges as per pre-established pricing structures, which are set by the rental service to each program data set transferred from storage system 235 to storage medium 100 and may consist of any pricing structure conceived and deemed satisfactory by the proprietors of the establishment utilizing the invention as a part of their service, and said payment account system may be an existing account system integrated into this system by an Application Programming Interface (API), or by some other method, or may be an account system designed specifically for this system. After account system correlation, playback criteria is assigned to each media content data file as per the protocol described above in FIG. 4 and is linked independently to each media content data file selected for transfer to storage medium 100. Prior to media content data file's storage on storage medium 100, media content data is encrypted and prepared for transport by a data encryption system 260. This encryption system may exist on the rental facility's computer system, register terminals, on an independent encryption device attached to, or independent of any other system, or any other system known to those skilled in the art to affect the encryption of the data, rendering it unusable outside of the scope of this invention. After encryption at data encryption system 260 the data is recorded to storage medium 100 and is ready for viewing at a remote location via playback device 140, and a viewing system similar to that described in FIG. 1, and/or FIG. 2. Those skilled in the art will recognize that myriad playback systems may be utilized that are substantially different that those described in FIG. 1, and/or FIG. 2, but that are still within the scope of this invention.

FIG. 5 shows a flow chart of a method that may be used to playback programs stored as data files on storage medium 100 of FIG. 3. In this embodiment of the invention, media content such as video programs, audio programs, or other proprietary or non-proprietary media content stored as data files on storage medium 100 are caused to be played back on a media content viewing component system similar to that described in FIG. 1, using playback device 140.

In this embodiment of the invention, storage medium 100 is placed in the receptacle provided on playback device 140, which causes playback device 140 to attempt to recognize storage medium 100 as an authorized and compatible device. Upon recognition of storage medium 100 as an authorized and compatible device, computer programmable logic resident on playback device 140 seeks and identifies media content program data files contained on storage medium 100. If no such files are recognized, playback device 140 sends a video signal to the viewing system as described in FIG. 1, and/or FIG. 2 displaying text indicating no data files found. If files are found, the files are prepared for de-encryption by de-encryption computer programmable logic corresponding to encryption provided by encryption and transport system 260, also resident in playback device 140. Computer programmable logic resident on playback device 140 confirms the status of the playback criteria, and, if any data files have expired their playback date or their number of viewing sessions allocated by the playback criteria, said logic triggers the deletion of said files from storage medium 100. Playback device 140 sends a video signal to the viewing system indicating the selection of data files available for viewing, and provides a graphical user interface displayed on the viewing system for navigation and selection of data files for viewing utilizing the remote control device 130. Upon selection of a file for viewing, playback device commences playback of the selected file, and offers myriad options for viewing, similar in substance to all viewing options available through other, standard viewing system available today. Such options may include, but are not limited to fast forward, slow play, rewind, fast rewind, stop, pause, menu of selections, etc. Those skilled in the art will recognize that any number of menu control options for viewing may or may not be included in the viewing options for any given embodiment of the invention.

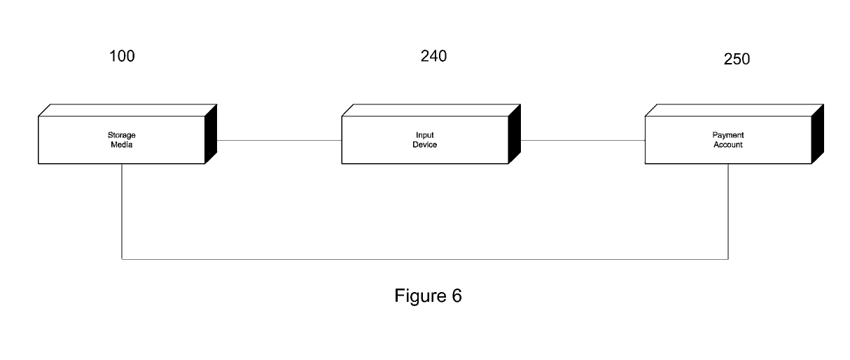

FIG. 6 shows a flow chart of a method that may be used to modify playback criteria for data-files recorded on storage medium 100 of FIG. 3. In this embodiment of the invention, playback criteria linked to media content data files stored on storage medium 100 is modified to allow an extension of the time allocated for viewing, or increase the number of viewing sessions allowed for said media content data files, and payment for said extension of time allocated for viewing or increase in number of viewing sessions is made.

In this embodiment of the invention, storage medium 100 is inserted into input device 240 as described in FIG. 4. In addition to the input device 240 described in FIG. 4, those skilled in the art will recognize that a personal computer with internet connectivity could serve as input device 240 provided a computer processor readable program is provided the user to affect the use of said personal computer as an input device. Upon insertion of storage medium 100 into input device 240, computer processor readable program code initiates a verification of status of all media content files and associated playback criteria stored on storage medium 100, correlates said status with the user's account on payment account system 250, and presents the user with a Graphic User Interface (GUI) which provides a menu of options, including, but not limited to account status, status of media content data files stored on storage medium 100, and an option to extend the time or number of viewing sessions for any or all of the media content data files stored on storage medium 100. If the user elects to increase the allocated viewing time, or increase the number of viewing sessions, the system modifies payment account 250 accordingly and debits the user account according to the pre-determined payment structure. Those skilled in the art will recognize that any number of variations exist for modification of both the account status and the media content file status through this embodiment of the invention, including adding and subtracting media content files from storage medium 100, debiting or crediting the user account, or any number of other modifications.

Thus, a method and apparatus for time/date and/or session-limited storage and playback of proprietary and non-proprietary media content utilizing re-writeable non-volatile memory. Although the invention has been described with respect to certain example embodiments, it will be apparent to those skilled in the art that the present invention is not limited to these specific embodiments. Further, although the operation of certain embodiments has been described in detail using certain detailed process steps, some of the steps may be omitted, the steps may be performed in different sequences, or other similar steps may be substituted without departing from the scope of the invention. Other embodiments incorporating the inventive features of the invention will be apparent to those skilled in the art.

What is claimed is:

1. A method for temporarily storing a set of data and/or a plurality of data sets on a re-writeable, non-volatile, solid-state storage media comprising, 1) obtaining data set(s) on a re-writeable, non-volatile, solid-state storage media device wherein said data sets are loaded to the storage media device at one location, allocated set playback criteria such as time limits, viewings, etc., and made available for playback at some remote location through a data-playback interface device, 2) applying playback criteria to each of a plurality of data sets stored on the storage media wherein the media resets the memory locations of each data set according to the playback criteria at the end of the pre-allocated viewing sessions, time limits, etc.

2. The method of claim 1 wherein said playback criteria specify only a number of said playback sessions.

3. The method of claim 1 wherein said playback criteria specify only a period of time for said playback sessions.

4. The method of claim 1 wherein said playback criteria specify both a period of time and a number of sessions for playback.

5. The method of claim 1 wherein said playback criteria are applied to a plurality of data sets wherein each has separate and different playback criteria.

6. The method of claim 1 wherein said predetermined number of playback sessions is one.

7. The method of claim 1 wherein said playback criteria is automatically pre-set during data loading based on acquired historical viewer playback characteristics.

8. The method of claim 1 wherein said playback criteria is modified by the user via remote access to the user's account over an Internet connection.

9. A playback device for playing back motion pictures and other audio/video programs or works comprising, 1) a storage medium access unit for retrieving data from said re-writeable, non-volatile, solid-state storage media, 2) a control unit comprising a computer processor for controlling operation of said storage medium access unit, 3) computer processor readable program code configured to cause said computer processor to retrieve playback criteria stored on said storage medium; and playback stored data set(s) according to said playback criteria.

10. An article of manufacture comprising a computer processor useable medium having computer processor readable program code embodied therein for playing back a data set or plurality of data sets stored on a re-writeable, non-volatile, solid-state storage media, having individually or grouped assigned playback criteria comprising computer processor readable program code configured to cause a computer processor to determine playback criteria applicable to each of the stored data sets and computer processor readable program code configured to cause a computer processor to select and play back said data sets according to the determined playback criteria.

11. An article of manufacture comprising a computer processor useable medium having computer processor readable program code embodied therein for analyzing playback criteria attached to a data set or plurality of data sets stored on a re-writeable, non-volatile, solid-state storage media comprising computer processor readable program code configured to cause a computer processor to cause the erasing of a data set or plurality of data sets based upon the analysis of the data's assigned playback criteria.

12. The article of manufacture of claim 10 wherein said playback criteria specify only a number of said playback sessions.

13. The article of manufacture of claim 10 wherein said playback criteria specify only a period of time for said playback sessions.

14. The article of manufacture of claim 10 wherein said playback criteria specify both a period of time and a number of sessions for playback.

15. The article of manufacture of claim 10 wherein said playback criteria are applied to a plurality of data sets wherein each has separate and different playback criteria.

16. The article of manufacture of claim 10 wherein said predetermined number of playback sessions is one.

17. The article of manufacture of claim 10 wherein said playback criteria is automatically pre-set during data loading based on acquired historical viewer playback characteristics.

18. The article of manufacture of claim 10 wherein said playback criteria is modified by the user via remote access to the user's account over an Internet connection.

19. The article of manufacture of claim 11 wherein said playback criteria specify only a number of said playback sessions to trigger the erasing of said data set.

20. The article of manufacture of claim 11 wherein said playback criteria specify only a period of time for said playback sessions to trigger the erasing of said data set.

21. The article of manufacture of claim 11 wherein said playback criteria specify both a period of time and a number of sessions for playback to trigger the erasing of said data set.

22. The article of manufacture of claim 11 wherein said playback criteria are applied to a plurality of data sets wherein each has separate and different playback criteria to trigger the erasing of said data set.

23. The article of manufacture of claim 11 wherein said predetermined number of playback sessions is one to trigger the erasing of said data set.

24. The article of manufacture of claim 11 wherein said playback criteria is automatically pre-set during data loading based on acquired historical viewer playback characteristics to trigger the erasing of said data set.

25. The article of manufacture of claim 11 wherein said playback criteria is modified by the user via remote access to the user's account over an Internet connection to trigger the erasing of said data set.

26. The article of manufacture of claim 10 wherein a portion of said playback criteria is provided by a playback device used to play back said sets of data.

27. The article of manufacture of claim 11 wherein a portion of said playback criteria is provided by a playback device used to play back said sets of data to trigger the erasing of said data set.

28. The article of manufacture of claim 10 wherein a portion of said playback criteria is recorded on said storage medium.

29. The article of manufacture of claim 11 wherein a portion of said playback criteria is recorded on said storage medium to trigger the erasing of said data set.

30. A player for playing back programs recorded on re-writeable, non-volatile, solid-state storage media, said player comprising, 1) a storage medium access unit configured to retrieve data from a re-writeable, non-volatile, solid-state storage medium having a single set or plurality of sets of prerecorded data, 2) a control unit comprising a computer processor for controlling operation of said storage medium access unit, 3) computer processor readable program code configured to cause said computer processor to retrieve playback criteria stored on said storage medium, said playback criteria identifying the criteria for playback of prerecorded data to be played back, play said programs through said player according to said criteria and optionally erase said programs from the re-writeable, non-volatile, solid-state storage media according to the playback criteria stored on said storage medium if erasing is not accomplished independent of the playback unit.
